(19) United States
(12) Patent Application Publication
(10) Pub. No.: US 2012/0298345 A1
(43) Pub. Date: Nov. 29, 2012

(54) HEAT SINK SHEET INCLUDING AN ADHESIVE HAVING GOOD HEAT CONDUCTIVITY

(75) Inventors: Won yong Hyeon, Pyeongtaek (KR); Mun seong Oh, Euiwang (KR); Gu Su Hong, Pyeongtaek (KR)

(73) Assignee: GREEN STAR CO., LTD., Pyeongtaek (KR)

(21) Appl. No.: 13/512,384

(22) PCT Filed: May 3, 2010
(86) PCT No.: PCT/KR2010/002789

§ 371 Date: May 29, 2012

(30) Foreign Application Priority Data
Feb. 17, 2010 (KR) 10-2010-0014177

(51) Int. Cl. F28F 7/00; B82Y 30/00

(52) U.S. Cl. 165/185; 977/742; 977/902

(57) ABSTRACT

The present invention relates to a heat sink sheet including an adhesive containing a carbon nano-complex and having good heat conductivity. The adhesive having good heat conductivity is coated on a graphite sheet to improve heat conductivity, and an existing adhesive process and adhesive coating process are combined into a single process to manufacture a heat sink sheet, thereby providing a heat sink sheet having improved heat conductivity so as to contribute to cost reduction and increased yield.

### TECHNICAL FIELD

The present invention relates to a heat sink sheet including an adhesive having excellent thermal conductivity, and, more particularly, to a heat sink sheet including an adhesive containing a carbon nanocomposite and having excellent thermal conductivity.

### BACKGROUND ART

Generally, electronic products, such as computers, portable terminals, communication appliances and the like, have problems of afterimage and system stability because they cannot diffuse excessive heat generated from the inside thereof to the outside thereof. Such excessive heat reduces the lifespan of a product, causes a breakdown and malfunction of a product, and, if extremely excessive, causes an explosion and a fire. Particularly, in plasma display panels (PDPs), LCD monitors and the like, excessive heat deteriorates color definition, thus reducing the reliability and stability of a product.

Therefore, the heat generated from the inside of a system must be dissipated to the outside thereof or must be cooled itself. Conventionally, methods for efficiently controlling such heat have been frequently attempted. Among these methods, a method of providing a heat sink or a radiation fan is generally used. However, a heat sink has low efficiency because the amount of heat that can be radiated by the heat sink is lower than the amount of heat emitted from a heating element of an electronic product. Therefore, both a heat sink and a radiation fan are provided, thus forcibly discharging the heat of the heat sink. However, a radiation fan is problematic in that it causes noise and vibration, and, most of all, it cannot be applied to light and slim products, such as plasma display panels (PDPs), notebook computers, portable terminals, etc.

Accordingly, a heat sink sheet interposed between a heating element and a radiation plate is widely used. The heat sink sheet is very effective because it efficiently transfers heat toward the radiation plate and absorbs a mechanical impact. Particularly, the heat sink sheet can be efficiently used for a PDP glass panel because the PDP glass panel is required to be light and slim and generates high-temperature heat using high-temperature plasma produced by gas discharge.

As examples of conventional heat sink sheets, Korean Unexamined Patent Publication No. 10-2001-0078953 discloses a heat sink sheet using a metal thin plate, which is provided to obtain heat transfer effects and heat dissipation effects using a ceramic layer, a metal thin plate and an adiabatic material, and which can exhibit excellent heat radiation effects if the contact area of a thermally conductive metal thin plate and a heating element is large. However, this heat sink sheet is problematic in that the manufacturing process thereof is complicated because it has a multi-layered structure, and in that it cannot effectively perform thermal conduction and thermal dissipation because the contact area of the metal thin plate and the heating element is small.

Further, Korean Unexamined Patent Publication No. 10-2003-0032769 discloses a heat sink sheet including copper powder, graphite powder, aluminum powder, ferrite powder, pure iron powder or the like in an amount of 10˜70 wt %, and Japanese Patent Application Nos. 2001-073564 and 2001-094620 disclose a heat sink sheet including aluminum powder in an amount of 50˜80 vol %. However, in the case where thermally-conductive powder is used as described above, when the amount of the thermally-conductive powder is excessively small, thermal conductivity is very low, and when the amount thereof is excessively large, the amount of other components becomes relatively small, so that the adhesivity between powder particles becomes low, thereby deteriorating workability. Particularly, even when the heat sink sheet includes pure iron having the highest thermal conductivity in an amount of about 70 wt %, the thermal conductivity of the heat sink sheet is less than 1.5 W/m·K, which is very low.

### DISCLOSURE

### Technical Problem

Accordingly, the present invention has been devised to solve the above-mentioned problems, and an object of the present invention is to provide a thermally-conductive heat sink sheet including a carbon nanocomposite, wherein the manufacturing process thereof is simple, thus reducing the manufacturing cost thereof and increasing the production yield thereof.

### Technical Solution

The above object is accomplished by the following technical means.

(1) A heat sink sheet including: a graphite sheet; and a thermally-conductive adhesive containing a carbon nanocomposite, the adhesive being formed on one side or both sides of the graphite sheet.

(2) In the heat sink sheet of (1), the carbon nanocomposite may include carbon nanotubes, and the carbon nanotubes may have an average particle size of 10˜20 nm.

(3) In the heat sink sheet of (2), the thermally-conductive adhesive may include: a carbon nanotube-dispersed solution obtained by mixing the carbon nanotubes with a solvent and then ultrasonically dispersing the mixture; and an acrylate polymer.

(4) In the heat sink sheet of (3), the thermally-conductive adhesive may further include a dispersant.

(5) In the heat sink sheet of (3), the carbon nanotubes may be added to the carbon nanotube-dispersed solution in an amount of 0.1˜20 wt %.

(6) In the heat sink sheet of (3), the carbon nanotubes may be surface-treated with an acid.

(7) In the heat sink sheet of (3), in the carbon nanotube-dispersed solution, the carbon nanotubes may be dispersed by irradiating the carbon nanotubes with ultrasonic waves of 300˜400 W/cm².

(8) In the heat sink sheet of (3), the solvent may be selected from the group consisting of aliphatic alcohols, aromatic organic solvents, and ketones.

(9) In the heat sink sheet of (3), the solvent may be isopropyl alcohol, toluene, ethyl acetate, or methyl ethyl ketone.

(10) In the heat sink sheet of (4), the dispersant may be polyvinyl pyrrolidone.

(11) In the heat sink sheet of (3), the thermally-conductive adhesive may include 1˜25 parts by weight of the carbon nanotube-dispersed solution based on 100 parts by weight of the acrylate polymer.

(12) In the heat sink sheet of (1), the graphite sheet may have a thickness of 0.1˜1.5 mm.

(13) In the heat sink sheet of (1), the graphite sheet may have a density of 0.8˜2.2 g/cm³.

### Advantageous Effects

According to the thermally-conductive heat sink sheet including a carbon nanocomposite of the present invention, the manufacturing process thereof is simple, thus reducing the manufacturing cost thereof and increasing the production yield thereof.

### DESCRIPTION OF DRAWING

FIG. 1 is a sectional view showing a heat sink sheet including a graphite sheet whose both sides are coated with a thermally-conductive adhesive according to the present invention.

### REFERENCE NUMERALS

1: graphite sheet
2: thermally-conductive adhesive
3: release paper

### BEST MODE

Hereinafter, the present invention will be described in detail.

The present invention provides a heat sink sheet including a thermally-conductive adhesive containing a carbon nanocomposite.

For this purpose, in the present invention, nanocarbons such as carbon nanotubes, carbon nanofibers and the like, and preferably carbon nanotubes, may be used to form the carbon nanocomposite.

The thermally-conductive adhesive constituting the heat sink sheet of the present invention is prepared by mixing a dispersion solution containing the nanocarbons with a polymer. In this case, the dispersion solution may include nanocarbons, a solvent and, if necessary, a dispersant. Hereinafter, for convenience, nanocarbons are limited to carbon nanotubes, and the present invention will be described based on carbon nanotubes. However, the scope of the present invention is not limited thereto.

The carbon nanotubes which can be used in the present invention may include single-wall carbon nanotubes, double-wall carbon nanotubes, multi-wall carbon nanotubes, and the like, and may not be particularly limited. The carbon nanotubes may have an average particle size of 10˜20 nm. Preferably, the carbon nanotubes may be surface-treated with an acid. Examples of the acid may include organic acids, such as citric acid, succinic acid, acetic acid, and the like, as well as inorganic acids, such as hydrochloric acid, sulfuric acid, nitric acid, and the like.

The amount of the carbon nanotubes in the dispersion solution may be 0.1˜20 wt %, preferably 0.5˜10 wt %, and more preferably 0.5˜5.0 wt %. When the amount thereof is less than 0.1 wt %, there is a problem in that thermal conductivity is remarkably deteriorated, and, when the amount thereof is more than 20 wt %, there is a problem in that the carbon nanotubes are not sufficiently dispersed, and are rapidly agglomerated.

If necessary, the dispersant may be selectively used. For example, polyvinyl pyrrolidone (PVP), polyvinyl alcohol (PVA), or the like may be used as the dispersant. The dispersant may be selectively added to a specific solvent in an amount of 0.1˜1.0 wt %. When the amount of the dispersant is less than 0.1 wt %, there is a problem in that the dispersability of the carbon nanotubes is deteriorated, and thus the carbon nanotubes are agglomerated, and, when the amount thereof is more than 1.0 wt %, there is a problem in that it is difficult to expect additional improvement effects. Therefore, it is preferred that the amount thereof be 0.1˜1.0 wt %.

The solvent used to form the dispersion solution may be used without limitation as long as the solubility of the carbon nanotubes in the solvent is good, and the dispersability of the carbon nanotubes in the solvent is not insufficient. For example, the solvent may be selected from the group consisting of aliphatic alcohols, aromatic organic solvents, and ketones. Preferably, the solvent may be isopropyl alcohol, toluene, ethyl acetate, or methyl ethyl ketone.

The carbon nanotube-containing dispersion solution is ultrasonically treated such that it does not agglomerate. For this purpose, the carbon nanotube-containing dispersion solution may be irradiated with ultrasonic waves of 300˜400 W/cm² for 3˜5 hours.

The carbon nanotube-containing dispersion solution may be mixed with 100 parts by weight of the acrylate polymer in an amount of 1˜25 parts by weight, preferably 5˜20 parts by weight, and more preferably 7˜15 parts by weight. When the amount thereof is less than 1 part by weight, there is a problem in that thermal conductivity is remarkably deteriorated, and, when the amount thereof is more than 25 parts by weight, there is a problem in that the carbon nanotubes agglomerate with the acrylate polymer.

The adhesive used in the present invention is not limited as long as it is a resin having adhesivity, such as an acrylate-based resin, a silicon-based resin, a polyurethane-based resin or the like. According to an embodiment of the present invention, the adhesive is obtained by mixing 20˜30 wt % of 2-ethylhexyl acrylate, 10˜20 wt % of n-butyl acrylate, 1˜2 wt % of 2-hydroxymethyl acrylate, 0.1˜0.5 wt % of 3-methacryloxypropylmethoxysilane, 0.05 0.1 wt % of a polymerization initiator, 30˜40 wt % of ethyl acetate, and 20˜30 wt % of toluene, slowly stirring the mixture while supplying nitrogen gas, and then polymerizing the stirred mixture for 6˜10 hours while maintaining the reaction temperature at 50˜70° C.

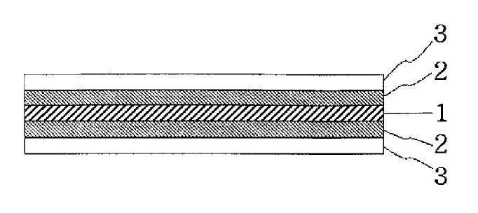

As shown in FIG. 1, the heat sink sheet having excellent thermal conductivity according to the present invention includes a graphite sheet 1, thermally-conductive adhesives 2 applied onto both sides of the graphite sheet 1, and release papers 3 attached onto the thermally-conductive adhesives 2.

In this case, the graphite sheet 1 used in the present invention may have a carbon content of 99% or more and a thermal conductivity of 5.0˜6.0 w/m·k (thickness direction).

The thickness of the graphite sheet 1 is not particularly limited, but may be 0.10˜1.5 mm. When the thickness thereof is less than 0.10 mm, there is a problem in that the graphite sheet 1 does not have sufficient strength, and thus may be broken, and, when the thickness thereof is more than 1.5 mm, there is a problem in that the graphite sheet 1 is easily delaminated, and the thermal conductivity and flexibility of the graphite sheet 1 in a thickness direction are deteriorated.

The density of the graphite sheet 1 is not particularly limited, but may be 0.8˜2.2 g/cm³. When the density thereof is less than 0.8 g/cm³, there is a problem in that the thermal conductivity and strength of the graphite sheet 1 are deteriorated, and, when the density thereof is more than 2.2 g/cm³, there is a problem in that the flexibility of the graphite sheet 1 is deteriorated.

The thermally-conductive adhesive 2 may be applied onto one side or both sides of the graphite sheet 1 using a transfer coating process or the like. In this case, the thickness of the thermally-conductive adhesive 2 may be 10˜30 μm. When the thickness thereof is less than 10 μm, there is a problem in that the adhesion between the graphite sheet 1 and the thermally-conductive adhesive 2 becomes low, and, when the thickness thereof is more than 30 μm, there is a problem in that the graphite sheet 1 is easily delaminated.

The release paper 3 is removed when it is attached to a heating element of an electronic product. The release paper 3 is not particularly limited as long as it can be freely detachably attached to the thermally-conductive adhesive 2. For example, a vinyl resin film, a polyester film, a paper coated with a releasable material, or the like may be used as the release paper 3.

### MODE FOR INVENTION

Hereinafter, the present invention will be described in more detail with reference to the following Examples. However, these Examples are set forth to illustrate the present invention, and the scope of the present invention is not limited thereto.

### Example 1

### Preparation of a Thermally-Conductive Adhesive

### a) Carbon Nanotube-Dispersed Solution

5 g of single-wall carbon nanotubes were surface-treated with 500 mL of 2N acetic acid. Subsequently, 0.3 wt % of polyvinyl pyrrolidone was mixed with 2 wt % of the surface-treated carbon nanotubes, 98 wt % of isopropyl alcohol and 100 wt % of a solvent to form a mixed solution, and then the mixed solution was irradiated with ultrasonic waves of 300˜400 W/cm² for 5 hours to disperse the carbon nanotubes in the mixed solution, thereby preparing a carbon nanotube-dispersed solution.

### b) Acrylate Polymer

21.55 wt % of 2-ethylhexyl acrylate, 13.71 wt % of n-butyl acrylate, 1.57 wt % of 2-hydroxymethyl acrylate, 0.39 wt % of 3-methacryloxypropylmethoxysilane, 0.08 wt % of 2,2′-azobisisobutyronitrille as a polymerization initiator, 39.18 wt % of ethyl acetate, and 23.52 wt % of toluene were put into a four-neck flask provided with a stirrer, a thermometer, a nitrogen gas supply pipe and a cooler, and then the mixture was slowly stirred while supplying nitrogen gas. The polymerization reaction of the stirred mixture was conducted for 8 hours while maintaining the temperature in the flask at 60° C. to obtain an acrylate polymer (yield: 40%).

### c) Thermally-Conductive Adhesive

10 wt % of the carbon nanotube-dispersed solution obtained in the step a) and 90 wt % of the acrylate polymer obtained in the step b) were mixed and dispersed to obtain a thermally-conductive adhesive.

### Example 2

### Preparation of a Thermally-Conductive Adhesive

A thermally-conductive adhesive was prepared in the same manner as in Example 1, except that double-walled carbon nanotubes were used.

### Example 3

### Manufacture of a Heat Sink Sheet

The thermally-conductive adhesive obtained in Example 1 was applied onto both sides of a graphite sheet having a thickness of 0.2 mm, a size of 300 mm×300 mm, a carbon content of 99.5% and a thermal conductivity of 5.5 w/m·k (thickness direction) using transfer coating such that the thickness of the applied thermally-conductive film is 25 μm, thereby manufacturing a heat sink sheet.

### Example 4

### Manufacture of a Heat Sink Sheet

A sink sheet was manufactured in the same manner as in Example 3, except that the thermally-conductive adhesive obtained in Example 2 was used.

### Example 5

### Manufacture of a Heat Sink Sheet

A sink sheet was manufactured in the same manner as in Example 3, except that 5 wt % of the carbon nanotube-dispersed solution was mixed with 95 wt % of the acrylate polymer.

### Comparative Example 1

A heat sink sheet having a thickness of 0.25 mm was manufactured by applying a commercially available adhesive onto a PET film (5 μm) to a thickness of 20 μm.

### Test Example 1

The thermal conductivity, surface resistance and detachability of the heat sink sheets manufactured in Examples 3 to 5 and Comparative Example 1 were evaluated, and the results thereof are given in Table 1 below. In this case, the thermal conductivity thereof was measured according to ASTM D 5470, and the surface resistance thereof was measured according to ASTM D 573.

TABLE 1

| | | | | Comparative |
|---|---|---|---|---|
| Test items | Example 3 | Example 4 | Example 5 | Example 1 |
| Thermal conductivity | 4.5 | 4.6 | 3.2 | 1.9 |
| (w/m · k) | | | | |
| Volume resistance (Ω) | 10 × 10¹² | 10 × 10¹² | 10 × 10¹² | 10 × 10¹³ |

Although the preferred embodiments of the present invention have been disclosed for illustrative purposes, those skilled in the art will appreciate that various modifications, additions, and substitutions are possible, without departing from the scope and spirit of the invention as disclosed in the accompanying claims.

### INDUSTRIAL APPLICABILITY

According to the thermally-conductive heat sink sheet including a carbon nanocomposite of the present invention, the manufacturing process thereof is simple, thus reducing the manufacturing cost thereof and increasing the production yield thereof.

1. A heat sink sheet, comprising:
a graphite sheet; and
a thermally-conductive adhesive containing a carbon nanocomposite, the adhesive being formed on one side or both sides of the graphite sheet.

2. The heat sink sheet of claim 1, wherein the carbon nanocomposite includes carbon nanotubes, and the carbon nanotubes have an average particle size of 10˜20 nm.

3. The heat sink sheet of claim 2, wherein the thermally-conductive adhesive includes: a carbon nanotube-dispersed solution obtained by mixing the carbon nanotubes with a solvent and then ultrasonically dispersing the mixture; and an acrylate polymer.

4. The heat sink sheet of claim 3, wherein the thermally-conductive adhesive further includes a dispersant.

5. The heat sink sheet of claim 3, wherein the carbon nanotubes are added to the carbon nanotube-dispersed solution in an amount of 0.1˜20 wt %.

6. The heat sink sheet of claim 3, wherein the carbon nanotubes are surface-treated with an acid.

7. The heat sink sheet of claim 3, wherein, in the carbon nanotube-dispersed solution, the carbon nanotubes are dispersed by irradiating the carbon nanotubes with ultrasonic waves of 300˜400 W/cm².

8. The heat sink sheet of claim 3, wherein the solvent is selected from the group consisting of aliphatic alcohols, aromatic organic solvents, and ketones.

9. The heat sink sheet of claim 3, wherein the solvent is isopropyl alcohol, toluene, ethyl acetate, or methyl ethyl ketone.

10. The heat sink sheet of claim 4, wherein the dispersant is polyvinyl pyrrolidone.

11. The heat sink sheet of claim 3, wherein the thermally-conductive adhesive includes 1˜25 parts by weight of the carbon nanotube-dispersed solution based on 100 parts by weight of the acrylate polymer.

12. The heat sink sheet of claim 1, wherein the graphite sheet has a thickness of 0.1˜1.5 mm.

13. The heat sink sheet of claim 1, wherein the graphite sheet has a density of 0.8˜2.2 g/cm³.
